(19) United States
(12) Patent Application Publication
(10) Pub. No.: US 2014/0310999 A1
(43) Pub. Date: Oct. 23, 2014

(54) DETACHABLE MEMBER

(71) Applicant: HEWLETT-PACKARD DEVELOPMENT COMPANY, L.P., Fort Collins, CO (US)

(72) Inventors: David Quijano, Ft. Collins, CO (US); Stacy L. Wolff, Houston, TX (US)

(73) Assignee: Hewlett-Packard Development Company, L.P., Fort Collins, CO (US)

(21) Appl. No.: 13/866,280

(22) Filed: Apr. 19, 2013

(51) Int. Cl. G09F 7/18; G09F 7/00

(52) U.S. Cl. CPC G09F 7/18; G09F 7/00; G09F 2007/1843; G09F 2007/1852; G09F 2007/1882
USPC 40/600; 40/606.01; 40/611.12

(57) ABSTRACT

In one example in accordance with the present disclosure, a system is provided. The system includes a housing and a detachable member. The housing comprises a recess, and the recess includes a protrusion to contact the detachable member and further includes a recessed bay. Depression of a portion of the detachable member causes the portion of the detachable member to sink into the recessed bay while an opposing portion of the detachable member protrudes from the housing.

### BACKGROUND

A logo is generally a symbol used by a commercial enterprise, an organization, or even an individual to aid and promote public recognition of a brand. In particular, a logo is typically placed on a product, marketing material, letter head, building, or another object associated with the commercial enterprise, organization, or individual to bring brand awareness. Some logos are purely graphic, while others are composed of text. In addition, some logos are composed of both graphics and text.

### BRIEF DESCRIPTION OF THE DRAWINGS

Examples are described in the following detailed description and in reference to the drawings, in which:

FIGS. 1(a)-1(e) depict a side view an example system in different phases of operation in accordance with an implementation;

FIGS. 2(a) and 2(b) depict an example system comprising a housing and/or detachable member with a magnet in accordance with an implementation;

FIG. 3 depicts two example displays with detachable members positioned in different orientations in accordance with an implementation;

FIGS. 4(a) and 4(b) depict a three-dimensional view of an example detachable member and housing in accordance with an implementation; and

FIGS. 5(a)-5(d) depict various detachable members in different orientations in accordance with various implementations.

### DETAILED DESCRIPTION

The present disclosure is generally directed to a detachable member and/or an associated housing architecture. More particularly, the present disclosure is generally directed to a novel and previously unforeseen architecture for a detachable member and associated housing which enables the member to be manually detached from the housing in a rapid and tool-less manner. In some examples, the detachable member may be removed, rotated, and re-inserted in the housing in a different orientation.

As mentioned in the foregoing, a logo may be placed on a product to aid and promote public recognition of a brand. For example, a logo may be placed on a liquid crystal display (LCD) to provide a viewer with instant recognition of the LCD's manufacturer. In particular, the logo may be placed on a single portion of the LCD housing (e.g., the lower edge of the housing), and be intended to be viewed from a single orientation (e.g., 0°).

A problem, however, exists when the product may be rotated and properly operate in a plurality of orientations (e.g., an LCD that properly operates at 0°, 90°, 180°, and 270°). In this case, the logo associated with the product may be appear upside down/sideways and be difficult to identify in certain product orientations. This is commonly the case when the logo comprises text (e.g., HP®) or a graphic that is meant to be viewed from a single orientation (e.g., the Nike® Swoosh).

Prior attempts have been made to rectify this situation by providing solutions to re-orient a logo, but such solutions have been, among other things, cumbersome to utilize and/or costly to implement. For example, one solution requires a plurality of tools and a significant amount of time to remove a product bezel, remove fasteners associated with a logo, and reinstall the logo in another orientation. Another solution requires a significant cost expenditure to submerge the logo in a liquid and utilize a magnet and/or gravity to automatically self-orient the logo as the product rotates.

Aspects of the present disclosure attempt to address the shortcomings of the above-mentioned solutions by providing an intuitive, tool-less, and cost-sensitive architecture that enables a detachable member (e.g., a logo, symbol, and/or text) to be removed and rotated. More particularly, aspects of the present disclosure provide a detachable member that is easily re-positionable without having to disassemble the product.

For instance, in one example implementation, a system is provided which comprises a housing and a detachable logo. The housing comprises a recess, and the recess comprises a protrusion and a recessed bay, where the protrusion is to contact the logo. Depression of a portion of the logo causes the portion of the logo to sink into the recessed bay while an opposing portion of the logo protrudes from the housing. A user may then grasp the protruding portion of the logo, remove the logo from the housing, and re-insert the logo in the recess in a different orientation.

In another example implementation, a system comprising a housing and a recess within the housing is provided. The recess comprises a protrusion to magnetically contact a detachable member, and further comprises at least two recessed bays adjacent to the protrusion. One of the at least two recessed bays is to receive a portion of the detachable member upon depression of the portion of the detachable member such that an opposing portion of the detachable member protrudes from the housing. A user may then grasp the protruding portion of the detachable member, remove the detachable member from the housing, and re-insert the detachable member in the recess in a different orientation.

In yet another example implementation, an electronic device comprising a housing and a manually detachable logo is provided. The housing comprises a recess that includes a protrusion and a recessed bay. The protrusion is to magnetically affix to the manually detachable logo, and depression of a portion of the manually detachable logo causes the portion of the manually detachable logo to sink into the recessed bay while an opposing portion of the manually detachable logo protrudes from the housing. A user may then grasp the protruding portion of the logo, remove the logo from the housing, and re-insert the logo in the recess in a different orientation.

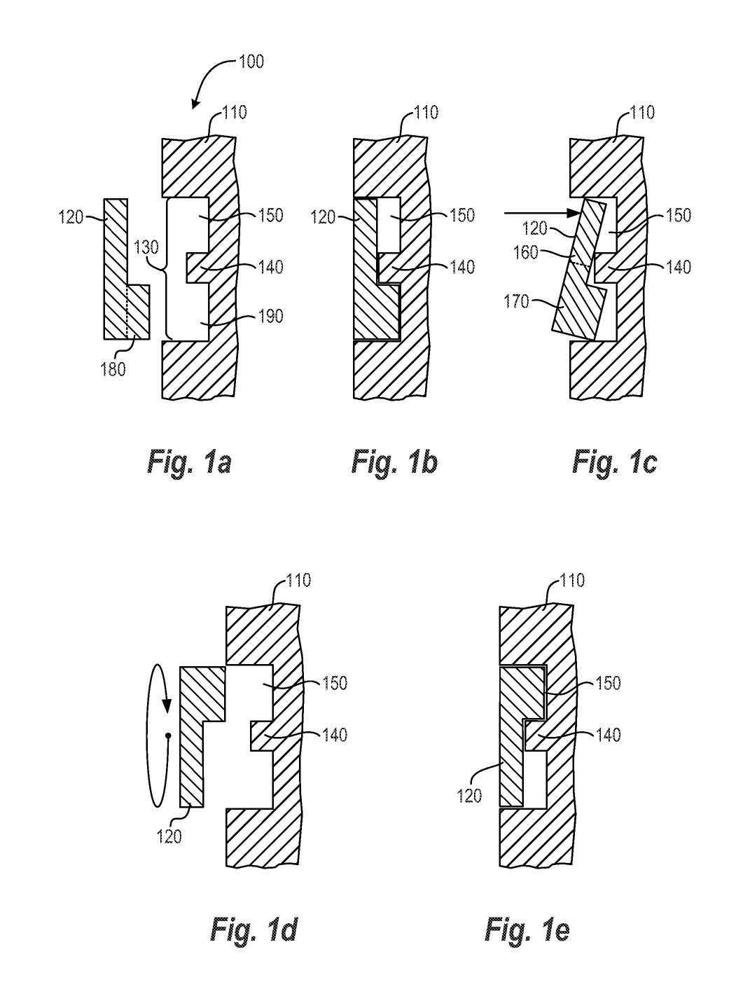

FIGS. 1(a)-1(e) depict a side view of an example system 100 in different phases of operation in accordance with an implementation. The system comprises a housing 110 and a detachable member 120. It should be readily apparent that the system 100 is a generalized illustration and that other elements may be added or existing elements may be removed, modified, or rearranged without departing from the scope of the present disclosure.

The system 100 generally comprises any type of product which may include the housing 110 and the detachable member 120. For example, the system 100 may comprise an electronic device (e.g., a display, a digital frame, a rack mounted hard disc drive, a rack mounted workstation, a computer, a television, a digital sign, or the like), a frame, a sign, a vehicle, a household appliance, furniture, or any other type of tangible product.

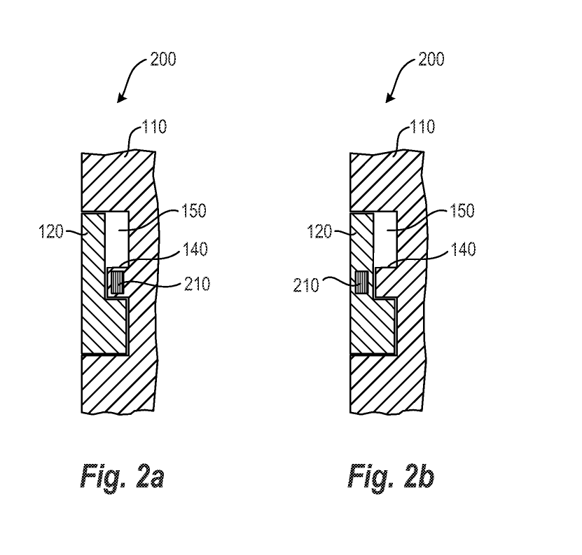

The housing 110 may form at least a portion of an outer surface the system. For example, the housing 110 may form at least a portion of an outer surface of a display. The housing 110 may be formed of one or more synthetic and/or naturally occurring materials (e.g., steel, aluminum, plastic, wood, etc.). In some implementations, and as discussed further with reference to FIG. 2(b) the housing 110 may be formed of a material with magnetic properties (e.g., steel), such that a magnet within or affixed to the detachable member 120 may be attracted to the housing 110.

The detachable member 120 generally comprises any type of member which may be positioned within the housing 110 and manually removed from the housing 110. For example, in some implementations, the detachable member 120 comprises a logo associated with a brand (e.g., HP®). In other implementations, the detachable member 120 comprises an emblem, symbol, or insignia not associated with a brand (e.g., a graphic image of a dragon). In still other implementations, the detachable member 120 comprises a customizable emblem, symbol, or insignia (e.g., a person's last name).

The detachable member 120 may be formed of one or more synthetic and/or naturally occurring materials (e.g., steel, aluminum, plastic, wood, etc.). In some implementations, and as discussed further with reference to FIG. 2(a) the detachable member 120 may be formed of a material with magnetic properties (e.g., steel), such that a magnet within or affixed to the housing 110 may be attracted to the detachable member 120.

The perimeter of the detachable member 120 may be a symmetrical shape. More particularly, in some implementations, when the detachable member 120 is inserted in the housing 110 and being viewed by a user facing the product, the perimeter of the detachable member 120 may have a symmetrical shape. For example, the detachable member 120 may have a circular shape or square shape. These shapes enable the detachable member 120 to be removed, rotated, and reinserted into the housing 110 at various angles (e.g., 0°, 90°, 180°, and 270°). In other examples, the detachable member is a rectangular or oval shape, such that the detachable member 120 may be removed, rotated, and reinserted into the housing 110 at fewer angles than mentioned above (e.g., 0° and 180°).

Turning now to system 100 operation, FIG. 1(a) depicts the detachable member 120 fully removed from the housing 110. As shown, the housing 110 comprises a recess 130. The perimeter of the recess 130 and the perimeter of the detachable member 120 may be the same shape (e.g., both the perimeter of the recess 130 and detachable member 120 may have a circular shape). The recess 130 comprises a protrusion 140 to contact the detachable member 120 when the detachable member 120 is inserted into the recess 130 (as shown in FIG. 1(b)). The recess 13 further comprises at least one recessed bay 150 adjacent to the protrusion. As shown in FIG. 1(c), upon depression of a portion 160 of the detachable member (see arrow indicating applied force), the portion 160 sinks into the recessed bay 150, while an opposing portion 170 of the detachable member protrudes from the housing 110. Because the opposing portion 170 of the detachable member is protruding from the housing 170, a user may grasp the opposing portion 170 and manually remove the entire detachable member 120 from the housing 110. Depending on the user's desire, the user may then, for example, rotate the detachable member 120 (as shown in FIG. 1(d)) and reinsert the detachable member 120 back into the housing 110 in another orientation (as shown in FIG. 1(e)). This may be helpful, for example, in the situation when the product may be utilized in multiple orientations, and the user would like to reposition the detachable member to match the current orientation of the product. Alternatively or in addition, the user may replace the detachable member 120 with a different detachable member and reinsert the different detachable member in the housing in the same or different orientation. This may be helpful, for example, when the product is being rebranded or when customized/interchangeable detachable members are being utilized.

It should be understood that while the detachable member 120 is shown in FIGS. 1(a)-1(e) with an “L-shaped” side view such that a protruding portion 180 of the detachable member 120 fits in one of the recessed bays (150 and 190) depending on the orientation, other shaped detachable members 120 are also possible. For example, the bottom surface of the detachable member 120 may be flat in some implementations (i.e., not include the protruding portion 180), and therefore a protruding portion 180 would not go into one of the recessed bays (150 and 190) when installed. In other implementations, there may be a protruding portion 180, but the shape of the protruding portion 180 may differ depending on how the product may be rotated. For example, the protruding portion 180 may be a hemisphere shape when viewing the back side of the detachable member 120 in situations when the product may only be oriented in two positions (e.g., 0° and 180°). In this case, the recessed bays (150 and 190) may have a similar hemisphere shape. Alternatively, the protruding portion 190 may be a pie shape when viewing the back side of the detachable member 120 in situations when the product may only be oriented in four positions (e.g., 0°, 90°, 180°, and 270°). In this case, the recessed bays (150 and 190) may have a pie shape, and there may be four such recessed bays.

FIGS. 2(a) and 2(b) depict an example system 200 comprising a housing 110 and/or detachable member 120 with a magnet 210. In particular, in various implementations, the detachable member 120 is affixed to the protrusion 140 within the housing 110 via a magnetic bond. As shown in FIG. 2(a), the magnet 210 may be located within or otherwise affixed to the protrusion 210 in some implementations. In this case, the detachable member 120 would be formed of a magnetically attractive material (e.g., steel, iron, nickel, cobalt, etc.) or have a magnetically attractive material portion such that the magnet 210 within the protrusion 140 would be magnetically attracted to the detachable member 120. As shown in FIG. 2(b), the magnet 210 may be located within or otherwise affixed to the detachable member 210 in some implementations. In this case, the housing 110 and/or protrusion 140 would be formed of a magnetically attractive material (e.g., steel, iron, nickel, cobalt, etc.) or have a magnetically attractive material portion such that the magnet 210 within the detachable member 120 would be magnetically attracted to the housing 110 and/or protrusion.

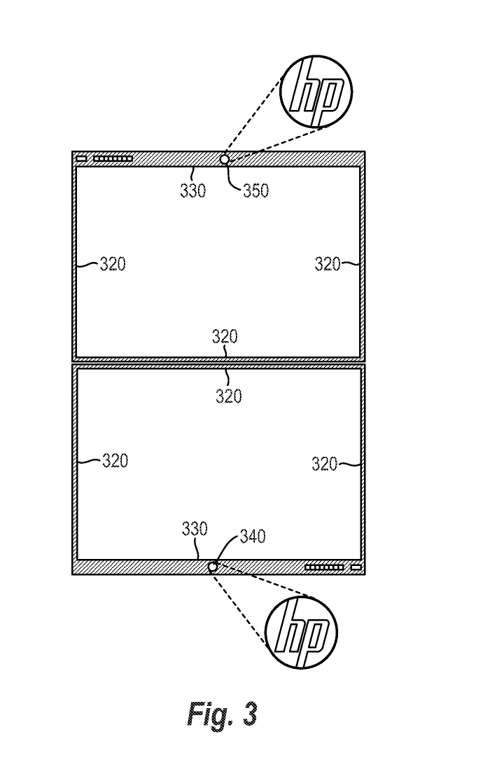

FIG. 3 depicts two example displays with detachable members positioned in different orientations in accordance with an implementation. More specifically, FIG. 3 depicts a first display 310 oriented at 0°, and a second display 320 positioned above the first display 310 and oriented at 180°. This configuration is quite common because displays often have three slimmer edges 320 and one wider edge 330 (typically the bottom edge with control buttons), and the user positions one display upside down (i.e., 180° rotation) so at to minimize the amount of housing present between the first display 310 and the second display 320.

As is depicted in FIG. 3 in the enlarged views, the first detachable member 340 is positioned in the same orientation as the second detachable member 350 notwithstanding the fact that the second display is upside down. This is accomplished via the operations depicted in FIGS. 1(a)-1(e). In particular, a user may depress a portion of the second detachable member 350 with the user's finger or another depression device, thereby causing the portion of the second member 350 to sink in the above-discussed recessed bay within the recess of the housing, while at the same time causing an opposing portion of the second detachable member 350 to protrude from the housing. The user may then grasp the opposing portion of the second detachable member 350, remove the second detachable member 350 from the housing, rotate the second detachable member 350 180°, and re-inserted the rotated second detachable member 350 into the housing. This process may be conducted rapidly, without tools, and without having to open/disassemble the housing. Hence, in a multi display environment comprising numerous displays in different orientations, a user may quickly re-orient the logos on each display so that each is oriented in the same direction. Alternatively, in a factory setting where a product is being rebranded, an employee may rapidly remove the logo associated with a first brand and insert a logo associated with a second brand in the rapid and tool-less manner.

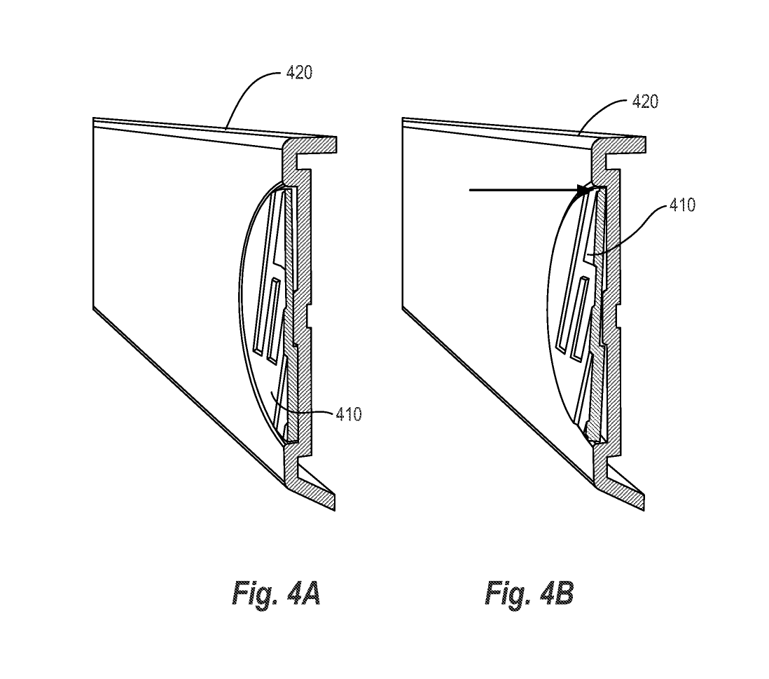

FIGS. 4(a) and 4(b) depict a three-dimensional view of an example detachable member and housing in accordance with an implementation. In particular, FIG. 4(a) provides a three-dimensional side view of the detachable member 410 within the recess within the housing. FIG. 4(b) provides a three-dimensional side view of the detachable member 410 with force being applied to an upper portion of the detachable member 410 (see arrow depicting applied force), and consequently the lower portion of the detachable member 410 is protruding from the housing 420. Accordingly, the lower portion of the detachable member 410 may be grasped and the entire detachable member 210 may be removed, rotated, and reinserted. This, as mentioned above, may be useful in situations when a product may be positioned in multiple orientations, or when a product is being rebranded.

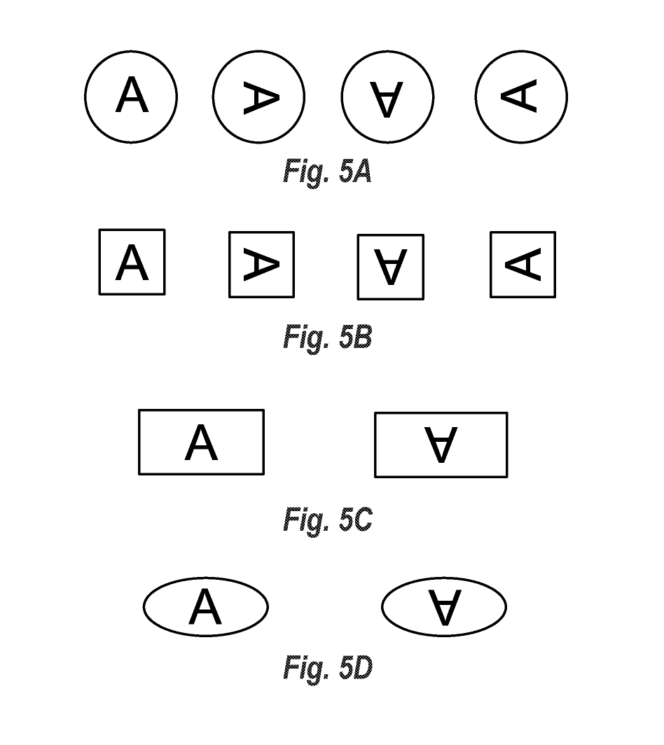

FIGS. 5(a)-5(d) depict various detachable members in different orientations in accordance with various implementations. In particular, FIG. 5(a) depicts a circular detachable member oriented at 0°, 90°, 180°, and 270°. In order for there to be four potential orientations, the bottom side of the detachable member may either be flat, or include a protruding portion (see, e.g., 180 in FIG. 1(a)) which may fit in each quadrant of the recess within the housing. Similarly, in order for there to be two potential orientations, the bottom side of the detachable member may either be flat, or include a protruding portion (see, e.g., 180 in FIG. 1(a)) which may fit in each hemisphere of the recess within the housing.

The same applies to the square detachable member depicted in FIG. 5(b). In order for there to be four potential orientations, the bottom side of the detachable member may either be flat, or include a protruding portion (see, e.g., 180 in FIG. 1(a)) which may fit in each quadrant of the recess within the housing. Similarly, in order for there to be two potential orientations, the bottom side of the detachable member may either be flat, or include a protruding portion (see, e.g., 180 in FIG. 1(a)) which may fit in each half of the recess within the housing.

Turning now to FIGS. 5(c) and 5(d), the detachable member is a rectangle and oval, respectively. Due to the shape, these detachable members may only be positioned in two orientations (i.e., 0° and 180°) because the detachable member would not fit back in the recess in the other two orientations (i.e., 90° and 270°). Thus, the bottom portion of the detachable members may either be flat, or include a protrusion which may fit in each half of the recess within the housing.

In some implementations, a piece of material may be affixed to the back of the detachable member and the housing. The piece of material may tether the housing and detachable member to one another so that the detachable member is not lost, misplaced, or even stolen upon removal of the detachable member from the housing. Depending of the implementation, the piece of material may be a string, cord, thread, fiber, plastic piece, or any other material that may flexibly link the detachable member and the housing. In some implementations, the tether may be a retractable tether such that it automatically retracts after the detachable member is pulled from the housing and released.

The foregoing provides a novel and previously unforeseen solution that enables rapid and tool-less removable of a detachable member such as a logo. Depending on the use case, the detachable member may be re-oriented and inserted into the housing, or replaced with an alternative detachable member and re-inserted. This may be useful, for example, in situations where products may properly operate in a plurality of orientations, or when a product is being rebranded. While the above disclosure has been shown and described with reference to the foregoing examples, it should be understood that other forms, details, and implementations may be made without departing from the spirit and scope of the disclosure that is defined in the following claims.

What is claimed is:

1. A system, comprising:
a housing; and
a detachable logo,
wherein the housing comprises a recess,
wherein the recess comprises a protrusion which is to contact the detachable logo, and wherein the recess further comprises a recessed bay, and
wherein depression of a portion of the detachable logo causes the portion of the detachable logo to sink into the recessed bay while an opposing portion of the detachable logo protrudes from the housing.

2. The system of claim 1, wherein at least one of the detachable logo and housing comprises a magnet.

3. The system of claim 1, wherein the perimeter of the recess and the perimeter of the detachable logo are the same shape.

4. The system of claim 1, wherein the logo is a symmetrical shape.

5. The system of claim 1, wherein at least one of the detachable logo and housing comprises a magnet.

6. The system of claim 1, wherein the detachable logo is positionable within the recess in at least a first direction and a second direction, wherein the first direction and second direction are 180 degrees apart.

7. The system of claim 1, wherein the detachable logo is positionable within the recess in at least a first direction and a second direction, wherein the first direction and second direction are 90 degrees apart.

8. A system comprising:
a housing; and
a recess within the housing,
wherein the recess comprises a protrusion to contact a detachable member,
wherein the recess comprises at least two recessed bays adjacent to the protrusion, and
wherein one of the at least two recessed bays is to receive a portion of the detachable member upon depression of the portion of the detachable member.

9. The system of claim 8, wherein the recess is to receive the detachable member in two different and opposing orientations.

10. The system of claim 8, wherein the housing comprises a magnet.

11. The system of claim 8, wherein the detachable member comprises a magnet.

12. The system of claim 8, wherein the detachable member comprises a logo associated with a brand.

13. The system of claim 8, wherein the detachable member comprises at least one of a symbol and text not associated with a brand

14. An electronic device, comprising:
a housing; and
a manually detachable logo,
wherein the housing comprises a recess that includes a protrusion and a recessed bay,
wherein the protrusion is to magnetically affix to the manually detachable logo, and
wherein depression of a portion of the manually detachable logo causes the portion of the manually detachable logo to sink into the recessed bay while an opposing portion of the manually detachable logo protrudes from the housing.

15. The electronic device of claim 14, wherein the manually detachable logo is positionable within the recess in at least a first direction and a second direction, wherein the first direction and second direction are 180 degrees apart.

16. The electronic device of claim 14, wherein the detachable logo is positionable within the recess in at least a first direction and a second direction, wherein the first direction and second direction are 90 degrees apart.

17. The electronic device of claim 14, wherein at least one of the manually detachable logo and the housing comprises a magnet.

18. The electronic device of claim 14, wherein the electronic device comprises a display.

19. The electronic device of claim 14, wherein the recess is formed on an edge of the housing that is wider than three other edges of the housing.

20. The electronic device of claim 14, wherein a piece of material tethers the housing and the manually detachable member.
